(19) United States
(12) Patent Application Publication
(10) Pub. No.: US 2003/0231104 A1
(43) Pub. Date: Dec. 18, 2003

(54) Portable-type memory medium with access restriction circuit

(76) Inventor: Shingo Ichikawa, Hyogo (JP)

Correspondence Address: WENDEROTH, LIND & PONACK, L.L.P., 2033 K STREET N. W., SUITE 800, WASHINGTON, DC, 20006-1021, US

(21) Appl. No.: 10/454,536

(22) Filed: Jun. 5, 2003

(30) Foreign Application Priority Data
Jun. 12, 2002 (JP) 2002-208942

(51) Int. Cl. H04Q 1/00

(52) U.S. Cl. 340/5.74

(57) ABSTRACT

The purpose of the present invention is to provide a portable-type memory medium such as a compact flash, a memory stick, etc., or a memory medium adapter that is to be connected to smart media, an SD card, a micromedia card, etc., concerning which the memory data [of that portable-type memory medium or medium adapter] cannot be accessed by another person if the personal identification numbers, etc., that are inputted from an external portion are not correct.

With the portable-type memory medium with access restriction circuit of the present invention, since the personal identification number, etc., to be inputted must be the correct ones, another person cannot access its memory data; and, through the encoding of data of the memory medium such as a flash memory, etc., it can be ensured that, even if disassembled, information data will not be leaked.

### FIELD OF THE INVENTION

The present invention is related to a portable-type memory medium such as a compact flash, a memory stick, etc., or to a memory medium adapter that is connected to smart media [SmartMedia™], an SD (secure digital) card, a Micromedia card, etc.

### DESCRIPTION OF THE PRIOR ART

In the case where a conventional portable-type memory medium has been lost, and then obtained by another person, since that other person can access that memory data, it has not been able to prevent the leakage of information data.

### OBJECT OF THE INVENTION

The purpose of the present invention is to, in order to resolve the above-described problem with prior art, provide a portable-type memory medium such as a compact flash, a memory stick, etc., or a memory medium adapter that is to be connected to smart media, an SD card, a Micromedia card, etc., concerning which the memory data [of that portable-type memory medium or memory medium adapter] cannot be accessed by another person if the personal identification numbers, etc., that are inputted from an external portion are not correct.

### MEANS FOR SOLVING THE OBJECT

In order to accomplish the purpose described above, the present invention proposes a portable-type memory medium, etc., comprising an access restriction circuit for restricting access to memory data via the input of personal identification numbers, etc., and a memory medium such as a flash memory, etc., to which access to its memory data is restricted by the stated access restriction circuit.

### BRIEF DESCRIPTION OF DRAWINGS

FIG. 1 is a conceptual diagram of the portable-type memory medium with an estriction circuit of the present invention; and

FIG. 2 is a conceptual diagram of the memory medium adapter with an access on circuit of the present invention.

### EMDBODIMENTS

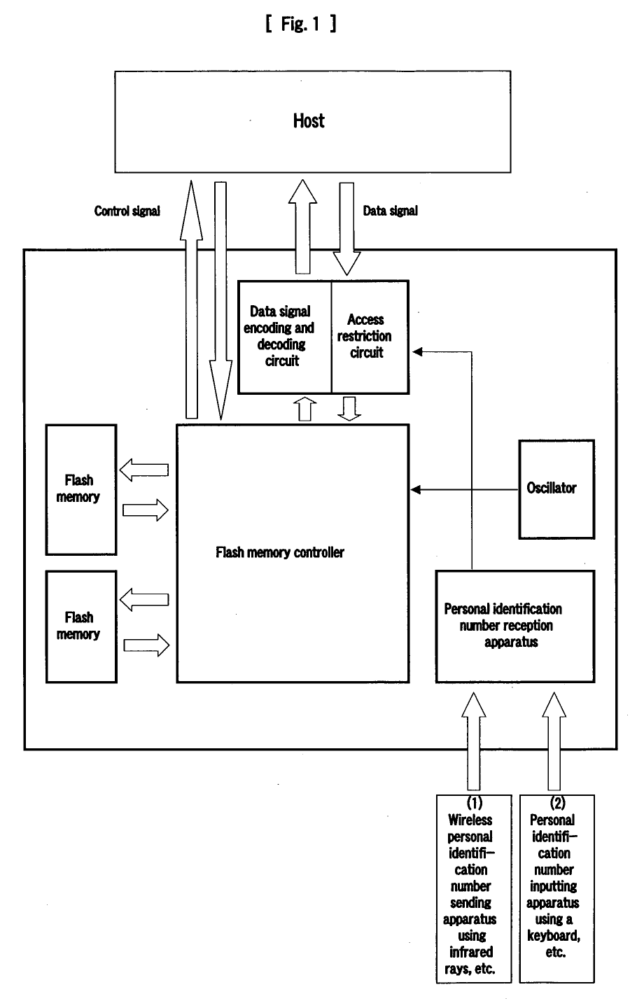

FIG. 1 shows the portable-type memory medium of the present invention; the stated portable-type memory medium is a compact flash, a memory stick, etc., and has a memory medium such as a flash memory, etc., for memorizing data in its internal portion.

It is possible to access from an external portion, via a flash memory controller internally installed within the memory media in the same way, the memory data of the stated memory medium.

Meanwhile, an access restriction circuit is provided for restricting access to data via the input of personal identification numbers, etc., into the memory.

The stated access restriction circuit is connected to the stated flash memory controller, and, through the input of a correct personal identification number, etc., it is possible to access memory data from an external portion (for example, an external computer); if the correct personal identification number, etc., is not inputted, then access is restricted.

In the example shown in the diagram, the access restriction circuit is configured such that personal identification numbers, etc., are inputted from an external portion using infrared rays.

As another example, personal identification numbers, etc., may be inputted from an external inputting apparatus that is connected to the access restriction circuit.

Further, as another example, an inputting apparatus may be provided that is connected to the access restriction circuit, and to which personal identification numbers, etc., are inputted.

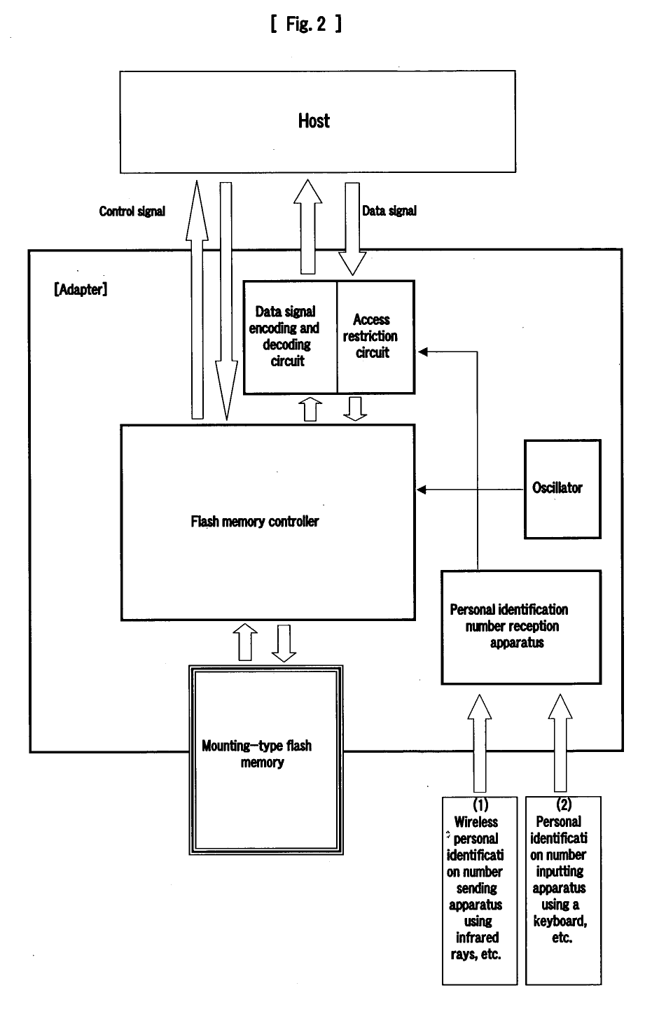

FIG. 2 shows the memory medium adapter of the present invention; the stated adapter is a memory medium adapter that is connected to smart media, an SD card, a Micromedia card, etc.

The stated adapter has an access restriction circuit for restricting access to memory data via the inputting of personal identification numbers, etc.

Shown in the diagram is an external memory medium such as a flash memory, etc., that is connected from an external portion, and concerning which access to its memory data may be restricted.

The memory data of this flash memory, etc. may be protected using the memory medium adapter of the present invention.

### EFFECTS OF THE INVENTION

The effects of the portable-type memory medium such as a compact flash, a memory stick, etc., or of the memory medium adapter that is to be connected to smart media, an SD card, a micromedia card, etc., are as follows below.

(1) With the portable-type memory medium with an access restriction circuit of the present invention, since the personal identification numbers, etc., to be inputted must be the correct ones, another person cannot access its memory data.

(2) with the portable-type memory medium with an access restriction circuit of the present invention, since the personal identification numbers, etc., to be inputted must be the correct ones, even if another person attempted to access its memory data, it is possible to ensure locking if personal identification numbers, etc., are mistaken, for example, three times, and it is also possible to, thereafter, ensure that unless there is inputted, for example, a 10-digit lock release number, then the lock cannot be released.

(3) with the portable-type memory medium with an access restriction circuit of the present invention, through the encoding of data of the memory medium such as a flash memory, etc., it can be ensured that, even if disassembled, information data will not be leaked.

What is claimed is:

1. A portable-type memory medium comprising an access restriction circuit for restricting access to memory data via the input of personal identification number, etc., and a memory medium such as a flash memory, etc., to which access to its memory data is restricted by said access restriction circuit.

2. A memory medium adapter having an access restriction circuit for restricting access to memory data via the input of personal identification numbers etc., and which is connected from an exterior portion to said access restriction circuit, and which is capable of storing data of an exterior memory medium such as a flash memory, etc., to which access to its memory data is restricted.

3. The portable-type memory medium of claim 1, to which personal identification numbers, etc., are inputted from an exterior portion to the access restriction circuit using infrared rays.

4. The memory medium adapter of claim 2, to which personal identification number, etc., are inputted from an exterior portion to the access restriction circuit using infrared rays.

5. The portable-type memory medium of claim 1, to which personal identification numbers, etc., are inputted with an external apparatus that is connected to the access restriction circuit.

6. The memory medium adapter of claim 2, to which personal identification numbers, etc., are inputted with an external inputting apparatus that is connected to the access restriction circuit.

7. The portable-type memory medium of claim 1, further comprising an external inputting apparatus, to which are inputted personal identification numbers, etc., and which is connected to the access restriction circuit.

8. The memory medium adapter of claim 2, further comprising an external inputting apparatus, to which are inputted personal identification numbers, etc., and which is connected to the access restriction circuit.

9. The portable-type memory medium of claims 1, 3, 5 and 7, wherein memory medium data is encoded and stored.

10. The memory medium adapter of claims 2, 4, 6 and 8, wherein memory medium data is encoded and stored.
